(19) United States
(12) Patent Application Publication
(10) Pub. No.: US 2004/0182114 A1
(43) Pub. Date: Sep. 23, 2004

(54) Method of producing porous glass-particle-deposited body and burner for synthesizing glass particles

(75) Inventors: Toshihiro Ooishi, Kanagawa (JP); Motonori Nakamura, Kanagawa (JP); Tatsuro Sakai, Kanagawa (JP)

Correspondence Address: MCDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/796,150

(22) Filed: Mar. 10, 2004

(30) Foreign Application Priority Data
Mar. 18, 2003 (JP) 2003-074112

(51) Int. Cl. C03B 37/018

(52) U.S. Cl. 65/413; 65/17.4

(57) ABSTRACT

A method of producing a porous glass-particle-deposited body by effectively depositing the glass particles synthesized by a burner for synthesizing glass particles on a starting member with increased bonding strength between the deposited glass particles and decreased possibility of developing cracks and other problems, and a burner to be used for the production method. In the method of producing the deposited body by depositing the glass particles synthesized by a burner on the surface of the starting member, the glass particle deposition surface has (a) a region that is hit by the center portion of the flame issuing from the burner and (b) another region that has a temperature higher than that of the region hit by the center portion of the flame and that is located at the outside of the region hit by the center portion of the flame.

### BACKGROUND OF THE INVENTION

1. Field of the Invention

The present invention relates to a method of producing a porous glass-particle-deposited body, the method comprising the step of depositing glass particles on the surface of a starting member, and to a burner for synthesizing glass particles, the burner being suitable for the production method.

2. Description of the Background Art

As a method of producing an optical fiber, a production method is known that comprises the steps of synthesizing an optical fiber preform consisting mainly of silica glass, elongating the preform, fire polishing, and drawing. Generally, the optical fiber preform is synthesized by the following steps.

(a) Glass particles are synthesized by using a burner for synthesizing glass particles.

(b) A porous glass-particle-deposited body is produced by depositing the glass particles on the surface of a starting member.

(c) The deposited body is dehydrated and consolidated to obtain a transparent body.

As the method of synthesizing the porous glass-particle-deposited body, a method called a soot process is known. The soot process comprises the following steps:

(a) The burner for synthesizing glass particles is supplied with:

(a1) a material gas such as, silicon tetrachloride (SiCl₄) or germanium tetrachloride (GeCl₄),

(a2) a combustible gas of hydrogen (Hd₂),

(a3) a combustion-assisting gas of oxygen (O₂), and, as required,

(a4) a carrier or sealing gas such as argon (Ar);

(b) Glass particles are vapor-phase synthesized by the flame hydrolysis of the material gas, for example; and

(c) A porous glass preform is synthesized by depositing the glass particles on the surface of a starting member placed in a reaction vessel.

The types of the well-known soot process include an outside vapor-phase deposition method (OVD method) and a vapor-phase axial deposition method (VAD method).

Various types of burners for synthesizing glass particles for use in the soot process are publicized. For example, the published Japanese patent application Tokukaishou 62-187135 has disclosed a burner that comprises a centrally positioned passage for ejecting a material gas and a plurality of small-bore passages for ejecting a combustion-assisting gas placed such that they surround the passage for ejecting a material gas. Another published Japanese patent application, Tokukaihei 5-323130, has disclosed a multifocus-type burner that also comprises a passage for ejecting a material gas and a plurality of passages for ejecting a combustion-assisting gas placed such that they surround the passage for ejecting a material gas. In this case, however, the passages for ejecting a combustion-assisting gas are arranged to form a plurality of annular layers and the combustion-assisting gases ejected from the passages in a different layer converge at a different point. Yet another published Japanese patent application, Tokukaihei 6-247722, has disclosed a burner that comprises a centrally positioned nozzle for a mixed gas of a material gas and an O₂ gas and small-bore nozzles for an O₂ gas placed such that they surround the nozzle for a mixed gas. According to the disclosure, the burner has a long life without relying on a sealing gas.

However, conventional methods of producing a porous glass-particle-deposited body by the soot process have the following drawback. Of the glass particles synthesized by the burner for synthesizing glass particles, only part of them are deposited on the surface of the starting member or of the deposited body being formed. The remaining portion is discharged to the outside of the reaction vessel together with the exhaust gas. Therefore, if the efficiency of the deposition of the glass particles on the surface of the starting member is increased over the conventional methods, the efficiency for the production of the deposited body can be increased with the reduction of the wasted material gas.

In the soot process, it is known that when the glass particles are deposited on the glass particle deposition surface, the reduction in the temperature of the deposition surface with respect to the temperature of the glass particles can increase the efficiency of the deposition of the glass particles. This phenomenon is known as the thermophoretic effect. Consequently, decrease in temperature of the deposition surface can increase the deposition efficiency. On the other hand, when the temperature of the deposition surface is reduced, the bonding strength between the deposited glass particles is decreased. As a result, the heat strain produced by heat cycles due to temperature rise and drop increases the rate of cracking in the obtained porous glass-particle-deposited body, decreasing the yield of the product.

### SUMMARY OF THE INVENTION

An object of the present invention is to offer a method of producing a porous glass-particle-deposited body, the method being capable of depositing glass particles on a glass particle deposition surface with high efficiency and being capable of increasing the bonding strength between the deposited glass particles, and to offer a burner for synthesizing glass particles, the burner being suitable for implementing the production method.

According to the present invention, the foregoing object is attained by offering the following method of producing a porous glass-particle-deposited body. The method comprises the following steps:

(a) Glass particles are synthesized with a flame issuing from a burner for synthesizing glass particles.

(b) The glass particles are deposited on the surface of a starting member (the surface is referred to as the glass particle deposition surface).

The method is specified by the condition that the glass particle deposition surface has:

(c) a region that is hit by the center portion of the flame; and

(d) another region that has a temperature higher than that of the region hit by the center portion of the flame and that is located at the outside of the region hit by the center portion of the flame.

Here, the term “starting member” is used to mean a member on the surface of which glass particles are to be deposited. The starting member may have a shape such as a cylindrical shape or a columnar shape according to the application. The type of member may be selected according to the application.

The term “porous glass-particle-deposited body” is used to mean a porous body produced by depositing the glass particles on the surface of the starting member. The deposited body can be further processed by consolidating it to obtain a transparent glass preform. Before the process for obtaining a transparent body, dehydration, addition of a dopant, or both can also be performed. The transparent glass preform can be used as the preform for producing an optical fiber, for example.

The term “glass particle deposition surface” is used to mean a surface on which glass particles contained in the flame for synthesizing glass particles are to be deposited. Before starting the deposition of the glass particles (sooting), the glass particle deposition surface is the surface of the starting member on which glass particles are yet to be deposited. After starting the sooting, the glass particle deposition surface is the surface of the porous glass-particle-deposited body that is being formed by the deposition of the glass particles.

According to one aspect of the present invention, the present invention offers the following burner for synthesizing glass particles. The burner comprises:

(a) a port for feeding a material gas placed at the center of the burner;

(b) a port for feeding a combustible gas; and

(c) at least two tubular ports for feeding a combustion-assisting gas placed such that:

(c1) at least one virtual concentric circle is drawn with respect to the port for feeding a material gas; and

(c2) a least two tubular ports for feeding a combustion-assisting gas are placed on the or each virtual concentric circle.

The burner is specified by the condition that the sum of the cross-sectional areas of the tubular ports for feeding a combustion-assisting gas is 1.7 to 5.5 times the cross-sectional area of the port for feeding a material gas.

Here, the term “material gas” is used to mean a gas to be used as the material for the glass. When a combustion-assisting gas or a combustible gas is mixed with the material gas, the mixed gas is regarded as the material gas.

The term “port” used as a part of a burner for synthesizing glass particles means an opening of a passage for a material gas or a combustion-assisting gas at the end of the burner from which these gases issue. The term “cross-sectional area of a port” is used to mean the area of the opening. The term “flow velocity” used with regard to a material gas or a combustion-assisting gas means the average flow velocity (m/s) of an individual gas at the exit of the port from which the gas issues.

Advantages of the present invention will become apparent from the following detailed description, which illustrates the best mode contemplated to carry out the invention. The invention can also be carried out by different embodiments, and their details can be modified in various respects, all without departing from the invention. Accordingly, the accompanying drawing and the following description are illustrative in nature, not restrictive.

### BRIEF DESCRIPTION OF THE DRAWING

The present invention is illustrated to show examples, not to show limitations, in the figures of the accompanying drawing. In the drawing, the same reference signs and numerals refer to similar elements.

In the drawing:

FIG. 1 is a schematic diagram explaining the OVD method, an embodiment of the soot process.

FIG. 2A is a diagram schematically showing a state when the flame hits the deposition surface in an embodiment of the method of producing a porous glass-particle-deposited body of the present invention, FIG. 2B is a graph schematically showing the temperature distribution on the deposition surface under the foregoing condition, and FIG. 2C is a graph schematically showing the two-dimensional temperature distribution on the deposition surface under the same condition.

FIG. 3A is a front view showing an embodiment of the burner for synthesizing glass particles to be used in the production method of the present invention, and FIG. 3B is a front view showing another embodiment of the burner to be used in the production method of the present invention.

FIG. 4 is a graph showing the deposition rate affected by the temperature difference between the region at which the central portion of the flame hits and the region at the outside of it.

FIG. 5 is a graph showing the comparison of the deposition rates of two burner for synthesizing glass particles having different port diameters as a function of the elapsed time of the sooting.

FIG. 6 is a graph showing the relationship between the flow velocity of the material gas and the deposition rate.

FIG. 7 is a graph showing the relationship between the distance from the top of the burner to the surface of the starting member and the deposition rate.

### DETAILED DESCRIPTION OF THE INVENTION

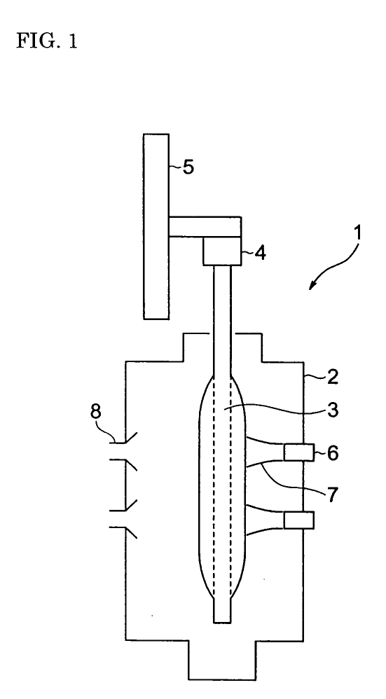

The production method of the present invention is explained below by referring to FIG. 1. FIG. 1 is a schematic diagram explaining the OVD method, an embodiment of the soot process. In an apparatus 1 for producing a porous glass-particle-deposited body, a starting member 3 is placed such that its rotation axis (longitudinal axis) is positioned nearly vertically and its top is coupled with a rotating device 4. The rotating device 4 is coupled with a raising-and-lowering mechanism 5. The starting member 3 is enclosed by a reaction vessel 2. Burners 6 for synthesizing glass particles are placed such that flames 7 issuing from the burners hit the surface of the starting member 3. The reaction vessel 2 is provided with gas-discharging ports 8 on its wall opposite to the wall provided with the burners 6 with respect to the starting member 3.

The burners 6 for synthesizing glass particles are supplied with a material gas, a combustible gas, a combustion-assisting gas, and, as required, a sealing gas or a carrier gas or both. Glass particles are synthesized by chemical reactions, such as (a) a flame hydrolytic reaction of the material gas by the water produced by the combustion reaction of the combustible gas and the combustion-assisting gas and (b) an oxidizing reaction with the combustion-assisting gas. The above-described reactions are well known.

Generally, the material gas is composed of SiCl₄ or, as required, the SiCl₄ is combined with a gas such as GeCl₄. Similarly, the combustible gas is composed of an H₂ gas and the combustion-assisting gas is composed of an O₂ gas. The sealing gas is used to prevent the glass particles from adhering onto the top surface of the burner for synthesizing glass particles or to prevent the top of the burner from overheating. The carrier gas is used to carry the material gas. Generally, the sealing gas, the carrier gas, or both are composed of a gas such as an inert gas, such as Ar, or a nitrogen gas, which has low reactivity. Sometimes, the carrier gas is composed of an O₂ gas. In the production method of the present invention, the above-described gases may be used.

The burners 6 for synthesizing glass particles eject the flames 7 containing glass particles to the starting member 3. Under this condition, the starting member 3 is rotated by the rotating device 4 and they are repeatedly moved up and down nearly vertically by the raising-and-lowering mechanism 5. Glass particles contained in the flames 7 issuing from the burners 6 are deposited on the surface of the starting member 3. The remaining glass particles without adhering to the starting member are discharged to the outside of the reaction vessel 2 through the gas-discharging ports 8 together with the exhaust gas produced by the flames 7.

FIG. 1 shows an embodiment in which the starting member 3 is moved up and down vertically. However, there are various alternatives as shown below.

(a) In place of the starting member 3, the burners 6 for synthesizing glass particles are caused to reciprocate.

(b) Both the starting member 3 and the burners 6 are caused to reciprocate in opposite directions.

(c) The starting member 3 is placed such that its rotating axis is positioned nearly horizontally, and the starting member 3, the burners 6, or both are caused to reciprocate to shift their relative positions repeatedly.

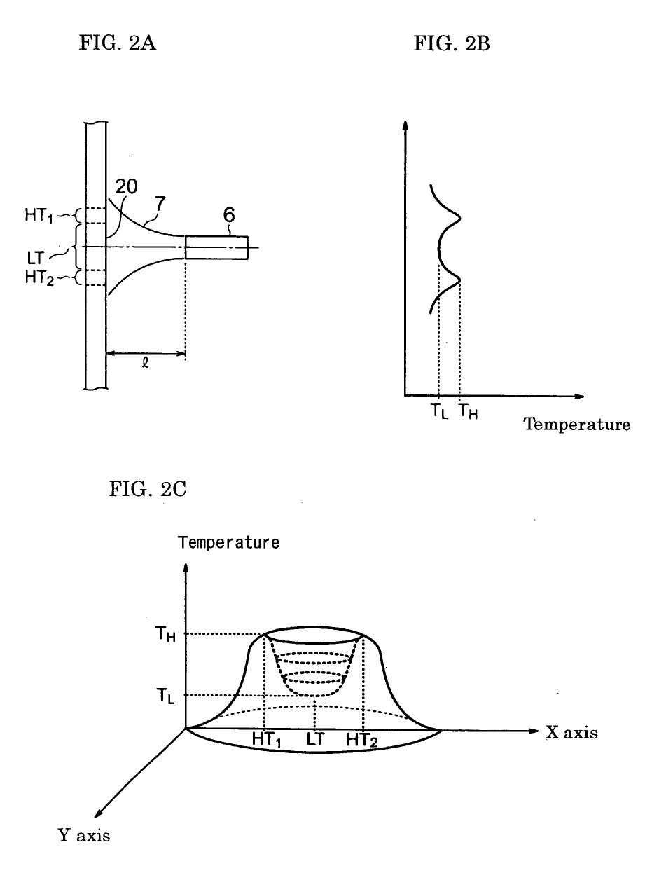

In the method of producing a porous glass-particle-deposited body of the present invention, while glass particles synthesized by the burner for synthesizing glass particles are deposited on the glass particle deposition surface, the deposition surface has a specific temperature distribution. FIG. 2A is a diagram schematically showing a state when the flame hits the deposition surface in an embodiment of the method of producing a porous glass-particle-deposited body of the present invention, and FIG. 2B is a graph schematically showing the temperature distribution on the deposition surface under the above-described condition.

In FIG. 2A, the center axis of the flame 7 is indicated by alternate long and short dashed lines. On the deposition surface 20, the region hit by the center portion of the flame 7 is referred to as a region LT, at the center of which the center axis of the flame 7 intersects the deposition surface 20. There are two regions at the outside of the region LT; one region includes a region HT₁ above the region LT and the other includes a region HT₂ below the region LT. The regions LT, HT₁, and HT₂ are regions on the deposition surface 20 determined by the position of the flame 7. They move according to the movement of the burner 6, the starting member 3, or both.

According to the method of producing a porous glass-particle-deposited body of the present invention, the method comprises the following steps:

(a) Glass particles are synthesized with a flame issuing from a burner for synthesizing glass particles.

(b) The glass particles are deposited on the surface of a starting member.

The glass particle deposition surface 20 has the following regions:

(c) the region LT that is hit by the center portion of the flame and that has a temperature of T_{L}; and

(d) the region HT₁, the region HT₂, or both that have a temperature of T_{H}, which is higher than T_{L}, and that are located at the outside of the region LT.

The deposition surface 20 has a vertical temperature distribution in which a maximum value T_{H} exists at both outsides of the central portion, which has a temperature of T_{L}.

The glass particles contained in the flame issuing from the burner for synthesizing glass particles have a distribution in which a majority of the glass particles exist in the center portion of the flame. When the glass particle deposition surface 20 has the above-described vertical temperature distribution, the deposition surface 20's region LT that is hit by the center portion of the flame has a relatively low temperature. The thermophoretic effect caused by this temperature distribution enables highly efficient deposition of the glass particles contained in the flame on the deposition surface. In addition, the relative reciprocating movement between the starting member and the burner moves the deposition surface 20's portion at the region LT to the region HT₁ or HT₂, which has a higher surface temperature. This movement increases the bonding strength between the deposited glass particles, preventing problems such as cracking in the porous glass-particle-deposited body.

FIGS. 2A and 2B show a case in which the glass particle deposition surface 20 has a temperature distribution in which one maximum value T_{H} exists at both outsides of the central portion, which has a temperature of T_{L}. However, the production method of the present invention is not limited to the above-described embodiment. The present invention only specifies that the deposition surface have a surface temperature region that exists at the outside of the region LT hit by the center of the flame 7 and that has a temperature higher than that of the region LT. Consequently, the deposition surface may have the regions HT₁ and HT₂ having different maximum temperatures. Furthermore, the region HT₁, the region HT₂, or both may have two or more local maximum temperatures.

Generally, the flame issuing from the burner for synthesizing glass particles has a rotationally symmetric shape whose center is the center axis of the flame. Consequently, when a flame issuing from a burner capable of producing the temperature distribution as shown in FIG. 2B on the glass particle deposition surface hits a plane, it produces a two-dimensional temperature distribution as shown schematically in FIG. 2C. In other words, the region that is hit by the center of the flame is surrounded by a region having a higher temperature as if a volcanic crater is surrounded by a somma.

One important factor for achieving the desirable temperature distribution on the glass particle deposition surface in the production method of the present invention is the structure of the burner for synthesizing glass particles. The burner to be used in the production method of the present invention comprises:

(a) a port for feeding a material gas placed at the center of the burner;

(b) a port for feeding a combustible gas; and

(c) at least two tubular ports for feeding a combustion-assisting gas placed such that:

(c1) at least one virtual concentric circle is drawn with respect to the port for feeding a material gas; and

(c2) a least two tubular ports for feeding a combustion-assisting gas are placed on the or each virtual concentric circle.

It is more desirable to place at least three ports for feeding a combustion-assisting gas on the or each virtual concentric approximate circle.

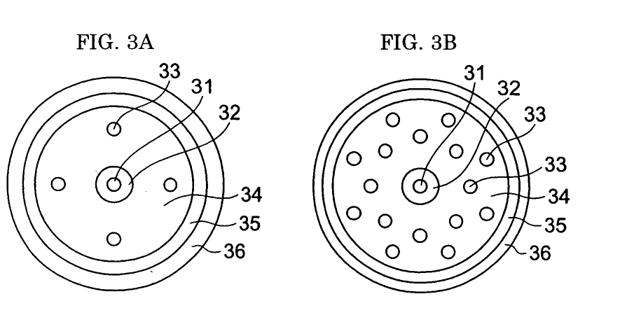

FIG. 3A is a front view showing an embodiment of the burner for synthesizing glass particles to be used in the production method of the present invention. FIG. 3B is a front view showing another embodiment of the burner to be used in the production method of the present invention. In FIGS. 3A and 3B, the circumference of a circle indicates a partition, which is generally made of silica glass. In other words, each circle's circumference shown in FIGS. 3A and 3B indicates the cross section of the pipe or tube made of, for example, silica glass.

The burner for synthesizing glass particles used in these embodiments comprises:

(a) a port 31 for feeding a material gas;

(b) an annular port 32 for feeding a sealing gas that encloses the port 31;

(c) a port 34 for feeding a combustible gas that encloses the port 32;

(d) at least two tubular ports 33 for feeding a combustion-assisting gas placed such that:

(d1) at least one virtual concentric circle is drawn with respect to the port 31 in the enclosure for the port 34; and

(d2) a least two tubular ports 33 are placed on the or each virtual concentric circle;

(e) an annular port 35 for feeding a sealing gas that encloses the port 34;

(f) an annular port 36 for feeding a combustion-assisting gas that encloses port 35.

The space separated by the partition is used as a port for feeding a gas. Table I shows desirable examples of the combination of gases to be fed into the individual ports. The sealing gas is not necessarily an essential member; an inter gas or a less-reactive gas, such as an N₂ gas, may be used, as required. Although not shown in the combinations in Table I, a carrier gas composed of an inert gas may be used for carrying a glass material.

TABLE I
Examples of the combination of gases to be fed
into the individual ports of the burner
shown in FIGS. 3A and 3B

| Port | | | |
|---|---|---|---|
| No. | Case 1 | Case 2 | Case 3 |
| 31 | Material gas | Material gas + | Material gas + |
| | | combustible gas | combustion- |
| | | | assisting gas |
| 32 | Sealing gas | Sealing gas | Sealing gas |
| 33 | combustion- | combustion-assisting | combustion- assisting |
| | assisting gas | gas | gas |
| 34 | combustible gas | combustible gas | combustible gas |
| 35 | Sealing gas | Sealing gas | Sealing gas |
| 36 | combustion- | combustion-assisting | combustion-assisting |
| | assisting gas | gas | gas |

It is desirable that the burner for synthesizing glass particles to be used in the present invention have tubular ports for feeding a combustion-assisting gas placed such that the combustion-assisting gases issuing from a plurality of ports placed on the or each virtual concentric circle converge at a point before or behind the intersection between the extended center axis of the port for feeding a material gas and the surface of the starting member 3. Hereinafter, the distance between the converging point of the combustion-assisting gases and the top of the burner is referred to as a focal length.

When the tubular ports for feeding a combustion-assisting gas are placed on two or more virtual concentric circles, the combustion-assisting gases issuing from the ports on a different virtual concentric circle converge at a different approximate point. The focal length is determined such that it increases with increasing radius of the virtual concentric circle. This arrangement suppresses the interference between the combustion-assisting gases issuing from the tubular ports placed on the virtual concentric circles having different radii. As a result, the flame issuing from the burner is prevented from being disturbed, the flow of the material gas is stabilized, and glass particles can be deposited on the glass particle deposition surface with high efficiency. Hereinafter, for the sake of explanation, the group of tubular ports for feeding a combustion-assisting gas placed on the same virtual concentric circle is referred to as a “layer.”

In addition, it is desirable that the combustion-assisting gases issuing from the tubular ports converge in a region where the flame itself is stable, more specifically, within some distance from the top of the burner where the flow of the material gas issuing from the burner is stable. If the converging point of the combustion-assisting gases is excessively remote from the top of the burner, the intensity of the flame decreases, decreasing the stability of the deposition of the glass particles on the glass particle deposition surface. On the other hand, if the amount of the combustion-assisting gas issuing from the tubular port is excessively large, the converging point is excessively close to the top of the burner, or both, the intensity of the flow of the combustion-assisting gas increases excessively in comparison with the flow of the material gas, disturbing the flow of the material gas.

When the number of “layers” is increased excessively even while the combustion-assisting gases converge at individual desirable points, the structure of the burner becomes complicated, the variations in the performance of the produced burner increases, and, moreover, the burner becomes costly. Therefore, in the burner to be used in the present invention, it is desirable that the number of “layers” of the tubular port for feeding a combustion-assisting gas be one to five, more desirably two to three.

As described above, in the burner for synthesizing glass particles to be used in the production method of the present invention, the material gas is fed into the flame from the port for feeding a material gas. In addition, when required, the material gas may be mixed with a combustion-assisting gas or a combustible gas to be fed into the flame. Furthermore, the material gas may be fed by using well-known methods such as a method in which an inert gas, an O₂ gas, or another gas is used as the carrier gas and a method in which a material compound that is a liquid at normal temperature is heated and vaporized to be fed as a gas.

In the production method of the present invention, the glass particle deposition surface heated by the flame issuing from the burner for synthesizing glass particles is required to have the above-described desirable temperature distribution. Under this condition of having the desirable temperature distribution, in order to further increase the efficiency of the deposition of the glass particles contained in the flame issuing from the burner on the deposition surface, it is required to achieve the following objectives, for example:

(a) to increase the efficiency of the chemical reaction by which the glass particles are synthesized from the material gas; and

(b) to stabilize the flow of the flame issuing from the burner so that the glass particles synthesized in the flame can arrive at the deposition surface with high efficiency.

To meet the above-described requirement, the present inventors carried out intensive studies on the desirable production conditions and found that it is desirable to implement the following measures:

(a) to use a burner having the above-described structure as a fundamental requirement;

(b) to adjust the flow velocity of the material gas at the port for feeding a material gas to fall within an optimum range;

(c) to adjust the ratio of the flow velocity of the combustion-assisting gas at the tubular port for feeding a combustion-assisting gas to the flow velocity of the material gas to fall within an optimum range; and

(d) to adjust the feeding amount of the combustion-assisting gas to fall within an optimum range.

To successfully carry out the above-described measures, the present inventors also found that it is desirable that the burner have a specific ratio of the sum of the cross-sectional areas of the tubular ports for feeding a combustion-assisting gas to the cross-sectional area of the port for feeding a material gas. These findings are explained below.

First, in the production method of the present invention, the desirable flow velocity of the material gas is explained below. The material gas is subjected to the hydrolytic reaction, the oxidizing reaction, or both in the flame to become glass particles. In the reaction, it is necessary for the combustion-assisting gas, water generated in the flame, or both to sufficiently diffuse into the material gas and mix with it in order to achieve highly efficient reaction of the material gas. Consequently, if the flow velocity of the material gas is excessively high, the combustion-assisting gas, water generated in the flame, or both cannot sufficiently diffuse into the material gas and mix with it during the travelling time from the burner to the glass particle deposition surface. As a result, the reaction becomes insufficient and unstable. More specifically, the amount of the deposited glass particles decreases with respect to the amount of the material gas, and, moreover, the obtained porous glass-particle-deposited body tends to have an increased longitudinal diameter fluctuation.

In addition, if the flow velocity of the material gas is excessively high, the ratio of the amount of the glass particles remaining without being deposited on the deposition surface to the amount of the glass particles contained in the flame increases undesirably. In the production method of the present invention, it is desirable that the flow velocity of the material gas at the port for feeding a material gas be less than 20 m/s, more desirably at most 19 m/s.

In contrast, if the flow velocity of the material gas is excessively low, the flow of the material gas is disturbed considerably by the flow of the combustion-assisting gas. This disturbance increases the amount of the glass particles that fail to arrive at the glass particle deposition surface, decreasing the efficiency of the deposition of the glass particles on the deposition surface. Therefore, it is desirable that the flow velocity of the material gas be at least 7 m/s, more desirably at least 10 m/s. In other words, the preferable range of the flow velocity of the material gas is 10 to 19 m/s.

Next, in the production method of the present invention, the desirable flow velocity of the combustion-assisting gas issuing from the tubular port and its desirable feeding amount into the flame are explained below. To synthesize the glass particles from the material gas in the flame with high efficiency, as described above, it is desirable to sufficiently diffuse the combustion-assisting gas into the material gas and mix with it. If the flow velocity of the combustion-assisting gas is excessively low, the combustion-assisting gas, water generated in the flame, or both cannot sufficiently diffuse into the material gas. As a result, the efficiency of the synthesis of the glass particles from the material gas decreases. In addition, not all of the fed combustion-assisting gas is consumed for the synthesizing reaction of the glass particles. What is more, the vitrifying reaction takes place when the material gas mixes with the combustion-assisting gas. Consideration of the above-described two facts indicates the necessity of feeding a greater amount of combustion-assisting gas into the flame than the amount required by the stoichiometry in order for the material gas to perform the synthesizing reaction sufficiently.

The feeding amount of the combustion-assisting gas necessary to meet the foregoing requirement is determined by the magnitude of items such as the flow velocity of the material gas and the below-described ratio of the cross-sectional area of the port for feeding a material gas to the sum of the cross-sectional areas of the tubular ports for feeding a combustion-assisting gas. In the production method of the present invention, it is desirable that the feeding amount of the combustion-assisting gas be 20 to 60 standard liter per minute (SLM), more desirably 30 to 50 SLM. This amount of combustion-assisting gas is fed into the flame from the tubular port for feeding a combustion-assisting gas. If required, part of the combustion-assisting gas to be used is mixed with the material gas so that it can be fed into the flame from the port for feeding a material gas together with the material gas.

Next, the desirable relationship between the flow velocity of the material gas and the flow velocity of the combustion-assisting gas issuing from the tubular port is explained below. In the production method of the present invention, in order to achieve a desirable temperature distribution on the glass particle deposition surface with an increased efficiency of the deposition of the glass particles on the starting member, it is desirable that the flow velocity of the combustion-assisting gas at the tubular port for feeding a combustion-assisting gas be at least 0.7 times and less than 2.0 times the flow velocity of the material gas at the port for feeding a material gas, more desirably in the range of at least 0.73 times and less than 2.0 times, yet more desirably in the range of 0.8 to 1.6 times, yet more desirably in the range of 0.9 to 1.2 times, preferably the same as the flow velocity of the material gas.

If the flow velocity of the combustion-assisting gas is less than 0.7 times that of the material gas, the diffusion and mixing of the combustion-assisting gas into the material gas becomes insufficient. If 2.0 times or more, the flow of the combustion-assisting gas disturbs the flow of the material gas, increasing the possibility of efficiency reduction in the deposition of the glass particles on the deposition surface. In addition, it is desirable that the flow velocity of the material gas be less than 20 m/s and that the feeding amount of the combustion-assisting gas be 20 to 60 SLM.

Next is the explanation of the condition under which the burner for synthesizing glass particles must operate in order to achieve the foregoing desirable range in (a) the flow velocity of the material gas, (b) the feeding amount of the combustion-assisting gas from the tubular port, and (c) the ratio of the flow velocity of the combustion-assisting gas to that of the material gas. To meet the above-described production requirements with an increased efficiency of the deposition of the glass particles on the starting member, it is desirable that the sum of the cross-sectional areas of the tubular ports for feeding a combustion-assisting gas be 1.7 to 5.5 times the cross-sectional area of the port for feeding a material gas, more desirably 2.0 to 5.0 times.

For example, when all of the tubular ports for feeding a combustion-assisting gas have a circular cross section with the same diameter of “B” and the number of tubular ports for feeding a combustion-assisting gas placed in the burner is “C” and the port for feeding a material gas placed at the center of the burner has a circular cross section with a diameter of “A,” it is desirable that the ratio of the cross-sectional area expressed as (B²×C)/A² be 1.7 to 5.5, more desirably 2.0 to 5.0. When the cross-sectional area of the port for feeding a material gas and the sum of the cross-sectional areas of the tubular ports for feeding a combustion-assisting gas have the above-described relationship, the above-described (a) flow velocity of the material gas, (b) feeding amount of the combustion-assisting gas from the tubular port, and (c) ratio of the flow velocity of the combustion-assisting gas to that of the material gas can be easily adjusted to fall within the desirable range.

Next is the explanation of the cross-sectional area of the port for feeding a material gas placed in the burner for synthesizing glass particles to be used in the present invention. In producing a porous glass-particle-deposited body, the cross-sectional area of the port for feeding a material gas can be determined such that the above-described flow velocity of the material gas can be achieved in accordance with the necessary amount of the material gas for feeding into the burner.

In the production method of the present invention, in order to increase the efficiency of the deposition of the glass particles on the deposition surface throughout the production process, it is desirable to change (a) the flow velocity of the material gas at the port for feeding a material gas, (b) the ratio of the flow velocity of the material gas to that of the combustion-assisting gas issuing from the tubular port, or (c) both as the diameter of the porous glass-particle-deposited body increases by the deposition of the glass particles on the deposition surface.

The reason is explained more specifically below. When the production of the porous glass-particle-deposited body is started, the glass particles are deposited directly on the starting member, which has a small diameter. Consequently, if the glass particles spread excessively in the flame, a large number of glass particles fail to hit the glass particle deposition surface of the starting member, decreasing the efficiency of the deposition of the glass particles on the deposition surface. Therefore, during the early stage of the production of the deposited body, it is desirable to maximally converge the glass particles synthesized in the flame on the deposition surface of the starting member without spreading them.

As the production of the deposited body proceeds, the diameter of the deposited body being formed increases due to the deposition of the glass particles on the starting member, decreasing the adverse effect of the spreading of the glass particles in the flame. Instead, however, the distance between the top of the burner for synthesizing glass particles and the deposition surface decreases. As a result, the reaction time may become insufficient for the glass particles to be synthesized from the material gas by the reaction in the flame.

Therefore, it is desirable that the flow velocity of the material gas be adjusted such that it is rather high at the start of the production and is decreased as the diameter of the deposited body increases in order to secure the reaction time sufficiently. More specifically, for example, the feeding amount of the combustion-assisting gas, the combustible gas, or both to be mixed with the material gas may be adjusted in accordance with the diameter of the deposited body being produced. The feeding amount of the material gas itself may also be adjusted to control the flow velocity of the material gas.

In addition, it is desirable that the distance between the top of the burner and the glass particle deposition surface be optimal both at the start and at the end of the production of the porous glass-particle-deposited body. This requirement is explained more specifically below. The starting member usually has a diameter of 10 to 40 mm, and the completed deposited body usually has a diameter of 150 to 300 mm. In view of these dimensions, it is desirable that the starting member and the burner for synthesizing glass particles be arranged such that the distance between the glass particle deposition surface and the burner is 150 to 500 mm at the start of the deposition of the glass particles in order to increase the efficiency of the deposition.

The production method of the present invention is explained below by referring to concrete examples. In these examples, the production apparatus shown in FIG. 1 was used with the modification of the number of burners for synthesizing glass particles from two to three.

### Example 1

A starting member having a diameter of 26 mm was used. Porous glass-particle-deposited bodies were produced by causing the starting member to reciprocate in relation to the burner for synthesizing glass particles at a speed of 200 mm/min. The starting member reciprocated for a distance of 1,600 mm. Under these conditions, the glass particles synthesized in the flame were deposited on the starting member by causing the flame issuing from the burner to hit the glass particle deposition surface for 400 minutes. During this process, measurements were conducted to evaluate the effect of the difference between the temperature T_{H} in the region HT₁ or HT₂ in the deposition surface and the temperature T_{L} in the region LT on the average deposition rate of the glass particles. The temperatures T_{L} and T_{H} were measured with an infrared thermal-image-measuring device. The average deposition rate was obtained by using the average value of the deposition amount for 400 minutes.

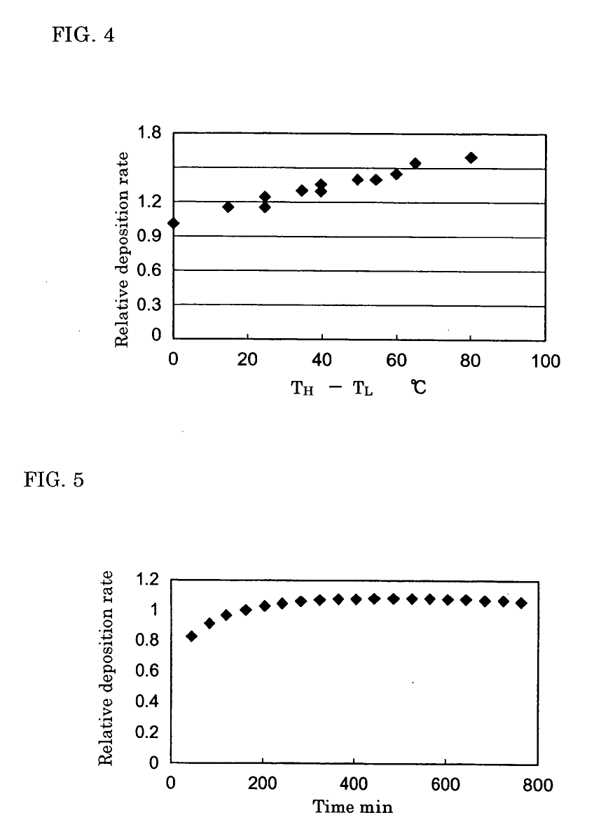

A burner having the same structure as shown in FIG. 3B was used for each test. Each test was conducted under the same condition in the flow rate of the material gas and the distance between the top of the burner and the deposition surface at the start of the production of the deposited body. The temperatures T_{L} and T_{H} were varied by changing the flow rate of the combustion-assisting gas issuing from the tubular port. The average deposition rate obtained in each test was converted to a relative value to the average deposition rate when the temperature difference is 0° C. (hereinafter the relative value is referred to as the relative deposition rate). Table II and FIG. 4 show the relationship between the relative deposition rate and the temperature difference expressed as T_{H}-T_{L}. In the above description, when the temperature difference is 0° C., the temperature in the region LT becomes highest in the deposition surface.

TABLE II

| T_{H} − T_{L} (° C.) | Relative deposition rate |
|---|---|
| 25 | 1.15 |
| 40 | 1.30 |
| 50 | 1.40 |
| 65 | 1.15 |
| 80 | 1.60 |
| 60 | 1.45 |
| 55 | 1.40 |
| 40 | 1.35 |
| 35 | 1.30 |
| 25 | 1.25 |
| 15 | 1.15 |

As can be seen from Table II and FIG. 4, the average deposition rate at a temperature.difference, T_{H}-T_{L}, of 80° C. is 1.6 times that at a temperature difference, T_{H}-T_{L}, of 0° C., showing the increase of 60% in the deposition efficiency of the glass particles. In the above description, the temperatures T_{L} and T_{H} are average values in 400 minutes for each test.

### Example 2

Two types of burners for synthesizing glass particles were used in this example. Burner 1 and Burner 2 had a structure according to the one shown in FIG. 3B with different diameters in the port for feeding a material gas and in the tubular port for feeding a combustion-assisting gas to each other. Porous glass-particle-deposited bodies were produced by using either one of the burners. The same flow rates of the material gas and the combustion-assisting gas issuing from the tubular port were employed for both Burners 1 and 2. However, in Burner 1, the flow velocity of the material gas was 12.15 m/s and that of the combustion-assisting gas issuing from the tubular port was 14.47 m/s (flow velocity ratio: 1.19). In Burner 2, the flow velocity of the material gas was 14.5 m/s and that of the combustion-assisting gas was 18.75 m/s (flow velocity ratio: 1.29).

During the test, the amount of the deposition of the glass particles on the starting member was measured at intervals of 40 minutes to calculate the average deposition rate during a period of 40 minutes immediately before the measurement. To obtain the relationship between the flow velocity ratio and the average deposition rate of the glass particles, the ratio of the average deposition rate during a period of 40 minutes immediately before the measurement when Burner 1 was used to that when Burner 2 was used was calculated (hereinafter the ratio is referred to as the relative deposition rate, also). Table III and FIG. 5 show the variation of the relative deposition rate as a function of the elapsed time of the deposition of the glass particles.

TABLE III

| Time (min) | Relative deposition rate |
|---|---|
| 40 | 0.82 |
| 80 | 0.91 |
| 120 | 0.96 |
| 160 | 1.00 |
| 200 | 1.02 |
| 240 | 1.04 |
| 280 | 1.06 |
| 320 | 1.07 |
| 360 | 1.07 |
| 400 | 1.08 |
| 440 | 1.08 |
| 480 | 1.08 |
| 520 | 1.08 |
| 560 | 1.08 |
| 600 | 1.08 |
| 640 | 1.08 |
| 680 | 1.07 |
| 720 | 1.07 |
| 760 | 1.06 |

As can be seen from Table III and FIG. 5, the average deposition rate when Burner 1 was used is larger than that when Burner 2 was used by about 8%. The likely reason for this result is that because in Burner 1, the flow velocity ratio is closer to 1.0 and the flow velocity of the material gas is lower than that in Burner 2, even when the progress of the deposition of the glass particles increases the diameter of the porous glass-particle-deposited body and thereby decreases the distance between the deposition surface and the burner, the reaction time for synthesizing the glass particles from the material gas can be maintained sufficiently long.

### Example 3

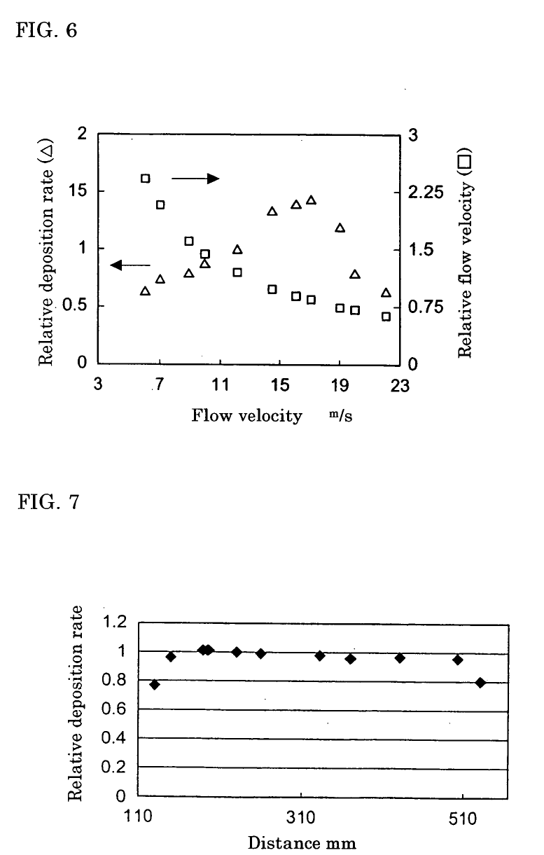

Burner 1 used in Example 2 was also used in this example. Eleven porous glass-particle-deposited bodies were produced under the condition that the flow rate of the combustion-assisting gas issuing from the tubular port is maintained constant and the flow rate of the material gas was varied. In the production of each deposited body, measurement was conducted to obtain the mass of the glass particles deposited during a period of 40 minutes after the start of the deposition of the glass particles on the starting member. The measured result was used to calculate the deposition amount of the glass particles per minute, which is the average deposition rate. The result was used to obtain the ratio to the average deposition rate obtained when the flow velocity of the material gas was 12.15 m/s (Example 2). The ratio is referred to as the relative deposition rate. The relationship between the flow velocity of the material gas (the ratio of the flow velocity of the combustion-assisting gas: 14.47 m/s to that of the material gas) and the relative deposition rate is shown in Table IV and FIG. 6. In Table IV and FIG. 6, the term “relative flow velocity” denotes the ratio of the flow velocity of the combustion-assisting gas to that of the material gas.

TABLE IV

| Flow velocity | Relative | Relative |
|---|---|---|
| (m/s) | flow velocity | deposition rate |
| 6.00 | 2.412 | 0.65 |
| 7.00 | 2.067 | 0.75 |
| 9.00 | 1.608 | 0.80 |
| 10.00 | 1.447 | 0.88 |
| 12.15 | 1.191 | 1.00 |
| 14.50 | 0.998 | 1.33 |
| 16.00 | 0.904 | 1.40 |
| 17.00 | 0.851 | 1.44 |
| 19.00 | 0.762 | 1.20 |
| 20.00 | 0.724 | 0.80 |
| 22.00 | 0.658 | 0.65 |

As can be seen from Table IV and FIG. 6, when the flow velocity of the material gas falls in the range of 7 to 20 m/s, a good average deposition rate can be obtained. When the range is narrowed to 10 to 19 m/s, the average deposition rate can be further improved. In addition, when the flow velocity of the combustion-assisting gas is at least 0.7 times and less than 2.0 times that of the material gas, a good average deposition rate can be obtained.

### Example 4

Burner 1 used in Example 2 was also used in this example to produce porous glass-particle-deposited bodies. In the burner, the following features were maintained constant: the flow velocity of the material gas was 14.5 m/s, the flow velocity of the combustion-assisting gas issuing from the tubular port was 14.47 m/s, and the relative flow velocity as defined in Example 3 was 0.998. However, the distance between the top of the burner and the surface of the starting member was varied to carry out tests. In each test, as with Example 3, measurement was conducted to obtain the average deposition rate of the glass particles during a period of 40 minutes after the start of the production of the deposited body. When the test was conducted with the distance between the top of the burner and the surface of the starting member being 200 mm, the obtained average deposition rate was used as a reference of 1.0. The average deposition rate obtained in each test conducted by varying the distance between the top of the burner and the surface of the starting member is expressed as a ratio to the average deposition rate obtained when the distance is 200 mm. The ratio is referred to as the relative deposition rate. Table V and FIG. 7 show the relationship between the distance and the relative deposition

TABLE V

| Distance (mm) | Relative deposition rate |
|---|---|
| 130 | 0.76 |
| 150 | 0.95 |
| 190 | 1.00 |
| 200 | 1.00 |
| 230 | 0.99 |
| 260 | 0.98 |
| 330 | 0.97 |
| 370 | 0.95 |
| 430 | 0.96 |
| 500 | 0.94 |
| 530 | 0.78 |

As can be seen from FIG. 7, the average deposition rate during a period of 40 minutes after the start of the production of the porous glass-particle-deposited body is stable when the distance between the top of the burner and the surface of the starting member falls in the range of 150 to 500 mm.

### Example 5

A test for producing a porous glass-particle-deposited body was carried out in two cases. In Case 1, the temperature of the central region where the central portion of the flame hits the glass particle deposition surface is highest in the deposition surface. In Case 2, the temperature of the foregoing central region is lower than that of the peripheral region surrounding it by 80° C. on the average. In the two cases, the starting member was sooted to produce a deposited body. The production was conducted by adjusting the flow rate of the material gas so that the temperature of the deposition surface where the center of the flame hits can become 600° C. The sooting on the starting member was performed for 10 hours for each case. In Case 1, the deposited body developed cracks in streaks four hours after the start of the sooting. In Case 2, no cracks developed.

The present invention is described above in connection with what is presently considered to be the most practical and preferred embodiments. However, the invention is not limited to the disclosed embodiments, but, on the contrary, is intended to cover various modifications and equivalent arrangements included within the spirit and scope of the appended claims.

The entire disclosure of Japanese patent application 2003-074112 filed on Mar. 3, 2003 including the specification, claims, drawing, and summary is incorporated herein by reference in its entirety.

What is claimed is:

1. A method of producing a porous glass-particle-deposited body, the method comprising the steps of:
(a) synthesizing glass particles with a flame issuing from a burner for synthesizing glass particles; and
(b) depositing the glass particles on the surface of a starting member (the surface is referred to as the glass particle deposition surface);
the method being specified by the condition that the glass particle deposition surface has:
(c) a region that is hit by the center portion of the flame; and
(d) another region that has a temperature higher than that of the region hit by the center portion of the flame and that is located at the outside of the region hit by the center portion of the flame.

2. A method of producing a porous glass-particle-deposited body as defined by claim 1, wherein:
(a) the burner for synthesizing glass particles comprises:
(a1) a port for feeding a material gas placed at the center of the burner;
(a2) a port for feeding a combustible gas; and
(a3) at least two tubular ports for feeding a combustion-assisting gas placed such that:
(a3a) at least one virtual concentric circle is drawn with respect to the port for feeding a material gas; and
(a3b) a least two tubular ports for feeding a combustion-assisting gas are placed on the or each virtual concentric circle;
(b) the burner is specified by the condition that the sum of the cross-sectional areas of the tubular ports for feeding a combustion-assisting gas is 1.7 to 5.5 times the cross-sectional area of the port for feeding a material gas.

3. A method of producing a porous glass-particle-deposited body as defined by claim 2, wherein the flow velocity of the combustion-assisting gas at the tubular port for feeding a combustion-assisting gas is at least 0.7 times and less than 2.0 times the flow velocity of the material gas at the port for feeding a material gas.

4. A method of producing a porous glass-particle-deposited body as defined by claim 2 or 3, wherein the flow velocity of the material gas at the port for feeding a material gas is decreased as the diameter of the porous glass-particle-deposited body being formed increases.

5. A method of producing a porous glass-particle-deposited body as defined by claim 1, wherein the distance between the glass particle deposition surface and the burner for synthesizing glass particles is 150 to 500 mm at the start of the deposition of the glass particles.

6. A burner for synthesizing glass particles, comprising:
(a) a port for feeding a material gas placed at the center of the burner;
(b) a port for feeding a combustible gas; and
(c) at least two tubular ports for feeding a combustion-assisting gas placed such that:
(c1) at least one virtual concentric circle is drawn with respect to the port for feeding a material gas; and
(c2) a least two tubular ports for feeding a combustion-assisting gas are placed on the or each virtual concentric circle;
the burner being specified by the condition that the sum of the cross-sectional areas of the tubular ports for feeding a combustion-assisting gas is 1.7 to 5.5 times the cross-sectional area of the port for feeding a material gas.
